(19) United States
(12) Patent Application Publication
(10) Pub. No.: US 2015/0054644 A1
(43) Pub. Date: Feb. 26, 2015

(54) INSTITUTIONAL ALARM SYSTEM AND METHOD

(71) Applicant: HELIX GROUP I LLC, Tumwater, WA (US)

(72) Inventors: Timothy J. KOWALSKI, Olympia, WA (US); Rob MAYA, Olympia, WA (US); Nick GRANT, Tumwater, WA (US); Josh STRAPAC, Port Orchard, WA (US); Ravinder GADE, Voorhees, NJ (US); Timothy A. GARCHOW, Tacoma, WA (US)

(21) Appl. No.: 14/463,347

(22) Filed: Aug. 19, 2014

Related U.S. Application Data
(60) Provisional application No. 61/867,989, filed on Aug. 20, 2013.

(51) Int. Cl. G08B 25/00

(52) U.S. Cl. CPC G08B 25/006
USPC 340/517

(57) ABSTRACT

Users configure Networks, Sites within Networks, User-Types, Event Types, other Users (of one or more User-Types), a Client Application, and authentication and authorization credentials. When authenticated and authorized, which may require that the Client Application utilize a specific network, the Client Application provides Alert Icons in a user interface of a mobile device, which Alert Icons may be used to initiate Alerts, respond to “Check In” requests, and control facility assets, such as computer controlled equipment monitoring and sensing equipment. Emergency services may also execute an emergency services application to view logs and to control facility assets.

### CROSS-REFERENCE TO RELATED APPLICATION

This application claims the benefit of U.S. Provisional Patent Application No. 61/867,989, filed Aug. 20, 2013, which application is incorporated herein by this reference.

### FIELD

This disclosure relates to a method and system to create institutional sites and sub-sites therein, alerts therein, and to respond to alerts therefrom.

### BACKGROUND

The following description includes information that may be useful in understanding the present invention. It is not an admission that any of the information provided herein is prior art or relevant to the presently claimed invention, or that any publication specifically or implicitly referenced is prior art.

Existing institutional security systems may be configured to allow security personnel to request fire, police, and emergency medical services (“EMS”) and may be configured to receive data from devices such as motion, intruder, water, smoke, and fire detectors as well as data from camera and video cameras, which data may be responded to with pre-programmed responses. The responses include contacting designated parties (including fire, police, and EMS), activating fire suppression, locking doors, and turning off valves for incoming water for a building.

Previous institutional security systems, however, do not allow administrators at an institutional facility, such as a school with a wide range of pre-existing facility assets, to configure customized alerts with customized alert responses, to enable a large number of faculty and staff at the institutional location to quickly and securely initiate alerts in response to emergency situations while reducing accidental alerts and limiting the locations from which alerts can be initiated, to control and monitor diverse pre-existing and future facility assets through one system, to provide a central point for observing and interacting with alert incidents, and to allow faculty, staff, and emergency responders to use mobile devices to initiate alerts, to communicate during the alert response, and to use mobile devices to initiate alerts and control existing facility assets, such as PA systems, during an alert.

### BRIEF DESCRIPTION OF THE DRAWINGS

FIG. 1 is a network and device diagram illustrating exemplary computing devices configured according to embodiments disclosed in this paper.

FIG. 2 is a functional block diagram of an exemplary Alert Server 200 computing device and some data structures and/or components thereof.

FIG. 3 is a functional block diagram of an Alert Datastore 300 illustrated in the computing device of FIG. 2.

FIG. 4 is a flowchart illustrating an embodiment of Alert Routine 400.

FIG. 5 is a flowchart illustrating an embodiment of User Configuration Routine 500.

FIG. 6 is a flowchart illustrating an embodiment of Device Contact Routine 600.

FIGS. 7A and 7B are a flowchart illustrating an embodiment of Authorized Alert Client Routine 700.

FIG. 8 is a flowchart illustrating an embodiment of ES Contact Routine 800.

FIG. 9 is a flowchart illustrating an embodiment of Site Report and Configuration Routine 900.

### DETAILED DESCRIPTION

The following Detailed Description provides specific details for an understanding of various examples of the technology. One skilled in the art will understand that the technology may be practiced without many of these details. In some instances, structures and functions have not been shown or described in detail or at all to avoid unnecessarily obscuring the description of the examples of the technology. It is intended that the terminology used in the description presented below be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the term “connected,” “coupled,” or any variant thereof means any connection or coupling, either direct or indirect between two or more elements; the coupling of connection between the elements can be physical, logical, or a combination thereof. Additionally, the words, “herein,” “above,” “below,” and words of similar import, when used in this application, shall refer to this application as a whole and not to particular portions of this application. When the context permits, words using the singular may also include the plural while words using the plural may also include the singular. The word “or,” in reference to a list of two or more items, covers all of the following interpretations of the word: any of the items in the list, all of the items in the list, and any combination of one or more of the items in the list.

Certain elements appear in various of the Figures with the same capitalized element text, but a different element number. When referred to herein with the capitalized element text but with no element number, these references should be understood to be largely equivalent and to refer to any of the elements with the same capitalized element text, though potentially with differences based on the computing device within which the various embodiments of the element appears.

As used herein, an “IP Address” is an Internet Protocol address with top levels assigned by the Internet Assigned Numbers Authority (“IANA”).

As used herein, an “SSID” stands for “service set identifier” and is an identifier of a network, also called a “network name”, which is broadcast by wireless base stations, such as Wi-Fi base stations and the like.

As used herein, “Content” comprises text, graphics, images (including still and video images), audio, graphical arrangement, and instructions for graphical arrangement which may, for example, be interpreted by browser applications or similar mobile computing device applications.

As used herein, a “Site” is a high school, middle school, elementary school, primary school, college, prison, or other institutional organization associated with at least one building.

As used herein, a “Network” is a collection of Sites, such as a school district or university which is a Network comprising multiple Sites.

As used herein, a “Facility Asset” is a device which can sense a state of or control a another device, mechanism, or machine in its environment, such as a remotely operated or sensed door lock, a power door, a water valve, an electrical circuit or circuit breaker, a public address (“PA”) system, a smoke and/or fire detection system, a fire suppression system, a phone system, a motion detector, a still or video camera, an electrical light, and the like, which devices are controlled by IP-based computer control systems or the like.

As used herein, “ES” stands for Emergency Services, as may be provided by, for example, fire, police, and medical services.

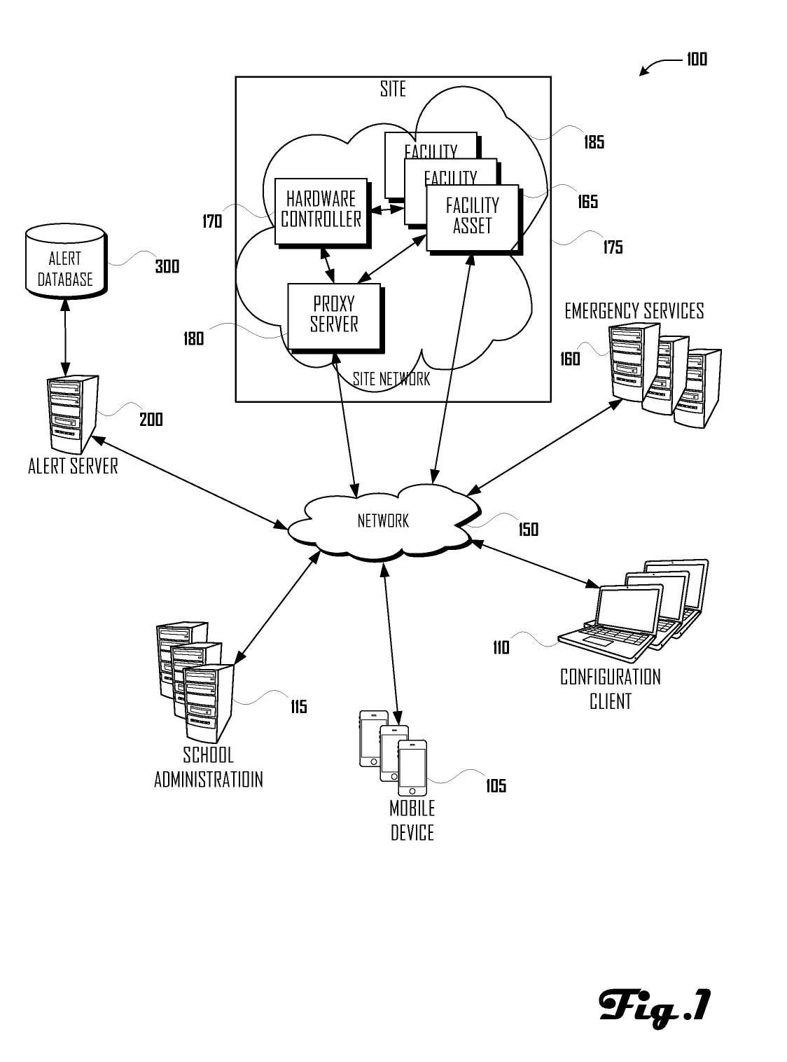

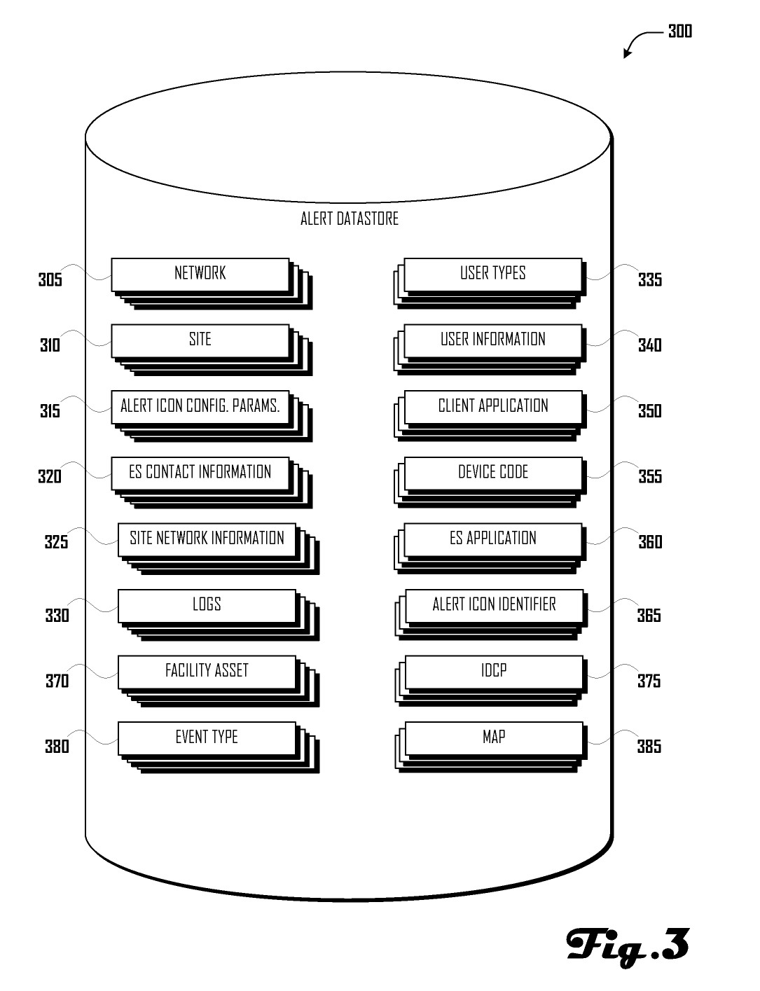

FIG. 1 is a network and device diagram illustrating exemplary computing devices configured according to embodiments disclosed in this paper. Illustrated in FIG. 1 are an Alert Server 200 and an Alert Database 300. The Alert Database 300 is discussed further in relation to FIG. 3. Generally, Alert Server 200 executes Alert Routine 400, which, in turn, executes Site Report and Configuration Routine 900, User Configuration Routine 500, and Device Contact Routine 600. Site Report and Configuration Routine 900, which may involve interaction between Alert Server 200 and Configuration Client 110, configures Networks 305, Sites 310, and User-Types 335 associated therewith. As discussed herein, User-Types 335 may be specific to Sites 310 or may apply across one or more Networks 305. User-Types 335 may comprise, for example, Super Administrator (a party with greater access privileges than others), Network Administrator (a party with privileges relative to a Network of Sites), Site Administrator (a party with privileges relative to a Site), and Site Users, such as Teacher, Administrator, Staff Member, and Counselor. As discussed herein, Site Report and Configuration Routine 900 may also be used to configure Alert Icon Configuration Parameters 315; as discussed herein, different sets of Alert Icon Configuration Parameters 315 may be organized according to Event Type 380. Event Types 380 may comprise, for example, a fire, a flood, a robbery, an earthquake, an assault, a kidnapping, a missing person, and an unauthorized person present at a site. As discussed herein, when User-Types 335 within a Site 310 or Network 305 download and execute Client Application 350 on Mobile Device 105 or on a browser in a non-mobile computer, Client Application 350 may present Alert Icons. As discussed herein, User Configuration Routine 500—which may involve interaction between Alert Server 200, Configuration Client 110, Mobile Device 105 and Client Application 350—may be used to obtain User Information 340 and to configure Users (of one or more User-Types 335) and authentication and authorization credentials which Users must present or be utilizing when activating Alerts.

As discussed herein, Users at Mobile Device 105 and/or a browser utilize Client Application 350 to authenticate and authorize with respect to Device Contact Routine 600. When authenticated and authorized—which may require that User access a Site Network 185 via a specific SSID—Client Application 350 provides Alert Icons (associated with Alert Icon Identifier 385) in a user interface in Mobile Devices 105, which Alert Icons Users may utilize to initiate Alerts, respond to “Check In” requests, and control Facility Assets 165 according to Alert Icon Configuration Parameters 315 (if any are relevant). ES may also execute an ES Application 360 to view Alert Logs 330 for Sites 310 and to control Facility Assets 165 associated with the ES.

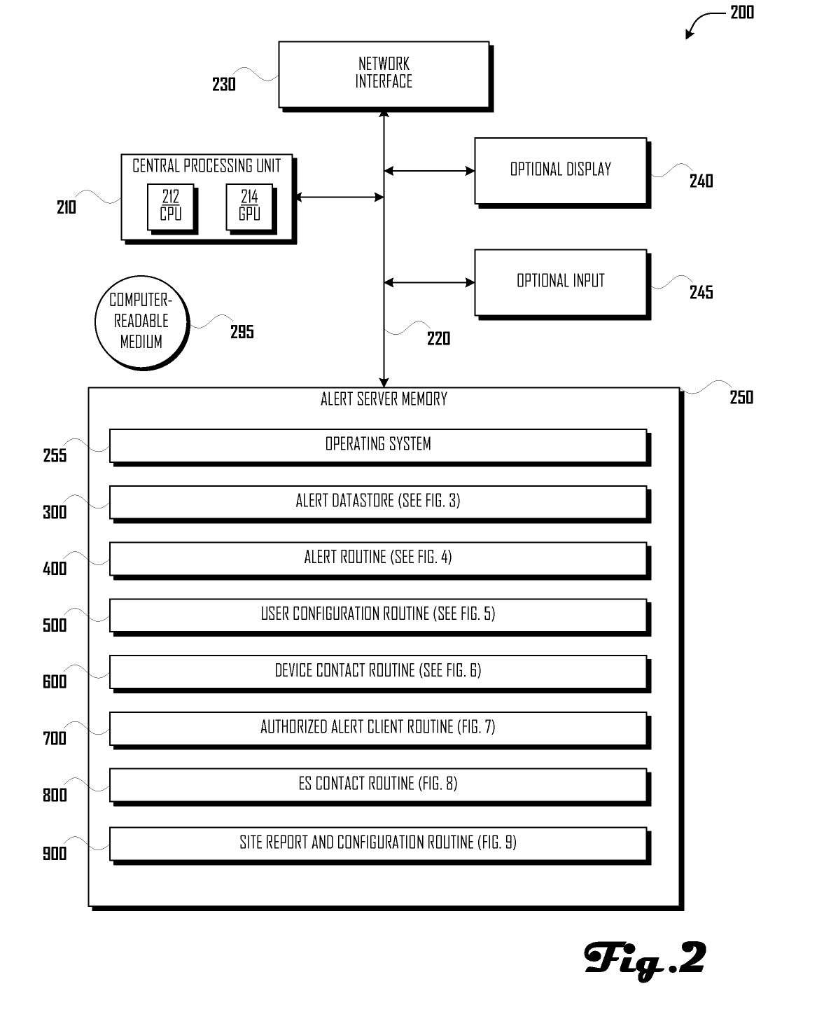

Also illustrated in FIG. 1 is Facility Asset 165, representing Facility Asset 1 to N. Facility Asset 165 may be located at or in, for example, Site 175. Facility Asset 165 may be controlled by, for example, Alert Server 200, either directly or via Proxy Server 180 and/or Hardware Controller 170. Proxy Server 180 and/or Hardware Controller 170 may be located in Site 175 or may be remote. Proxy Server 180 and/or Hardware Controller 170 may connect to Facility Asset 165 via Network 150, via Site Network 185, and/or may connect to Facility Asset 165 directly. Proxy Server 180 may provide security functions, discussed below, and may connect to Facility Assets 165 and/or Hardware Controller 170 from within a network at Site 175, such as Site Network 185. Proxy Server 180, Hardware Controller 170, and Facility Asset 165 may be computing devices, similar to the computing device illustrated in FIG. 2; for example, Proxy Server 180 may be provided by routines executed by a Raspberry Pi or the like hardware installed in Site Network 185.

FIG. 1 also illustrates Emergency Serves 160 (representing ES 1 to N), Configuration Client 110 (representing Configuration Client 1 to N), School Administration 115 (representing School Administration 1 to N), and Mobile Device 105 (representing Mobile Device 1 to N). Mobile Device 105 may be a mobile or non-mobile computer device, such as, for example, a mobile phone, a tablet, laptop, personal computer, gaming computer, media playback computer, or the like. Mobile Device 105 represents any computing device capable of executing Client Application 350 or ES Application 360. Mobile Devices 105 are used by “Users.” Client Device 105 may interact with User Contact Routine 600. Emergency Serves 160, Configuration Client 110, and School Administration 115 may also be mobile or non-mobile computing devices, such as, for example, a mobile phone, a tablet, laptop, personal computer, gaming computer, media playback computer, or the like.

In FIG. 1, the computing machines may be physically separate computing devices or logically separate processes executed by a common computing device. Certain components are illustrated in FIG. 1 as connecting directly to one another (such as, for example, Alert Database 300 connecting to Alert Server 200), though the connections may be through Network 150. If these components are embodied in separate computers, then additional steps may be added to the disclosed invention to recite communicating between such components.

Network 150 comprises computers, network connections among the computers, and software routines to enable communication between the computers over the network connections. Examples of Network 150 comprise an Ethernet network, the Internet, and/or a wireless network, such as a GSM, TDMA, CDMA, EDGE, HSPA, LTE or other network provided by a wireless service provider. Connection to Network 150 may be via a Wi-Fi connection. More than one network may be involved in a communication session between the illustrated devices. Connection to Network 150 may require that the computers execute software routines which enable, for example, the seven layers of the OSI model of computer networking or equivalent in a wireless phone network. Connection to Network 150 requires the use of an IP address. A network similar to Network 150 may be present in Site 175, such as Site Network 185 which may be, for example, an Ethernet network.

This paper may discuss a first computer as connecting to a second computer (such as Mobile Device 105 connecting to Alert Server 200) or to a corresponding datastore (such as to Alert Database 300); it should be understood that such connections may be to, through, or via the other of the two components (for example, a statement that a computing device connects with or sends data to Alert Server 200 should be understood as saying that the computing device may connect with or send data to Alert Database 300). References herein to “database” should be understood as equivalent to “datastore.” Although illustrated as components integrated in one physical unit, the computers and databases may be provided by common (or separate) physical hardware and common (or separate) logic processors and memory components. Though discussed as occurring within one computing device, the software routines and data groups used by the software routines may be stored and/or executed remotely relative to any of the computers through, for example, application virtualization.

FIG. 2 is a functional block diagram of an exemplary Alert Server 200 computing device and some data structures and/or components thereof. Alert Server 200 in FIG. 2 comprises at least one Processing Unit 210, Alert Server Memory 250, a Display 240 and Input 245, all interconnected along with Network Interface 230 via Bus 220. Processing Unit 210 may comprise one or more general-purpose Central Processing Units (“CPU”) 212 as well as one or more special-purpose Graphics Processing Units (“GPU”) 214. The components of Processing Unit 210 may be utilized by Operating System 255 for different functions required by the routines executed by Alert Server 200. Network Interface 230 may be utilized to form connections with Network 150 or to form device-to-device connections with other computers. Alert Server Memory 250 generally comprises a random access memory (“RAM”), a read only memory (“ROM”), and a permanent mass storage device, such as a disk drive or SDRAM (synchronous dynamic random-access memory).

Alert Server Memory 250 stores program code for software routines, such as, for example, Alert Routine 400, User Configuration Routine 500, Device Contact Routine 600, Authorized Alert Client Routine 700, ES Contact Routine 800, and Site Report and Configuration Routine 900 as well as, for example, browser, email client and server routines, client applications, and database applications (discussed further below). Additional data groups for routines, such as for a webserver and web browser, may also be present on and executed by Alert Server 200 and the other computers illustrated in FIG. 1. Webserver and browser routines may provide an interface for interaction among the computing devices, for example, through webserver and web browser routines which may serve and respond to data and information in the form of webpages and html documents or files. Browsers and webservers are meant to illustrate machine- and user-interface and user-interface enabling routines generally, and may be replaced by equivalent routines for serving and rendering information to and in interfaces in a computing device (whether in a web browser or in, for example, a mobile device application or via an application program interface or “API”). For example, Client Application 350 and/or ES Application 360 may be executed as an “app” by Mobile Device 105 and/or may be executed on a browser (as stated above, Mobile Device 105 may be a laptop or desktop computer and/or may otherwise execute a browser to provide certain functions of Client Application 350 and/or ES Application 360).

In addition, Alert Server Memory 250 also stores Operating System 255. These software components may be loaded from a non-transient Computer Readable Storage Medium 295 into Alert Server Memory 250 of the computing device using a drive mechanism (not shown) associated with a non-transient Computer Readable Storage Medium 295, such as a floppy disc, tape, DVD/CD-ROM drive, memory card, or other like storage medium. In some embodiments, software components may also or instead be loaded via a mechanism other than a drive mechanism and Computer Readable Storage Medium 295 (e.g., via Network Interface 230).

Computing device 200 may also comprise hardware supporting input modalities, Input 245, such as, for example, a touchscreen, a camera, a keyboard, a mouse, a trackball, a stylus, motion detectors, and a microphone. Input 245 may also serve as Display 240, as in the case of a touchscreen display which also serves as Input 245, and which may respond to input in the form of contact by a finger or stylus with the surface of the Input 245.

Computing device 200 may also comprise or communicate via Bus 220 with Alert Datastore 300, illustrated further in FIG. 3. In various embodiments, Bus 220 may comprise a storage area network (“SAN”), a high speed serial bus, and/or via other suitable communication technology. In some embodiments, Alert Server 200 may communicate with Alert Datastore 300 via Network Interface 230. Alert Server 200 may, in some embodiments, include many more components than those shown in this Figure. However, it is not necessary that all of these components be shown in order to disclose an illustrative embodiment.

FIG. 3 is a functional block diagram of an Alert Datastore 300 illustrated in the computing device of FIG. 2. The components of the Alert Datastore 300 are data groups used by routines and are discussed further herein in the discussion of other of the Figures. The data groups used by routines illustrated in FIG. 3 may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, joins, conditional logic, tests, and similar.

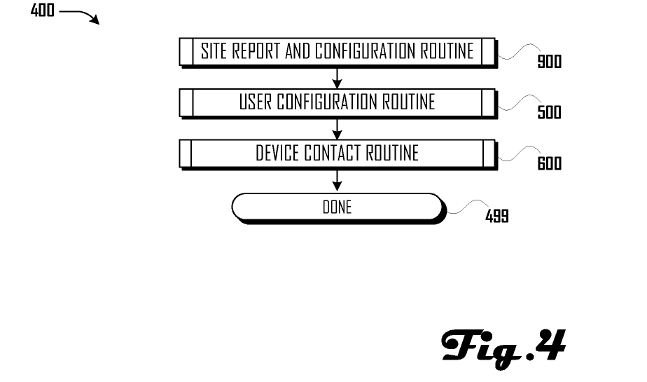

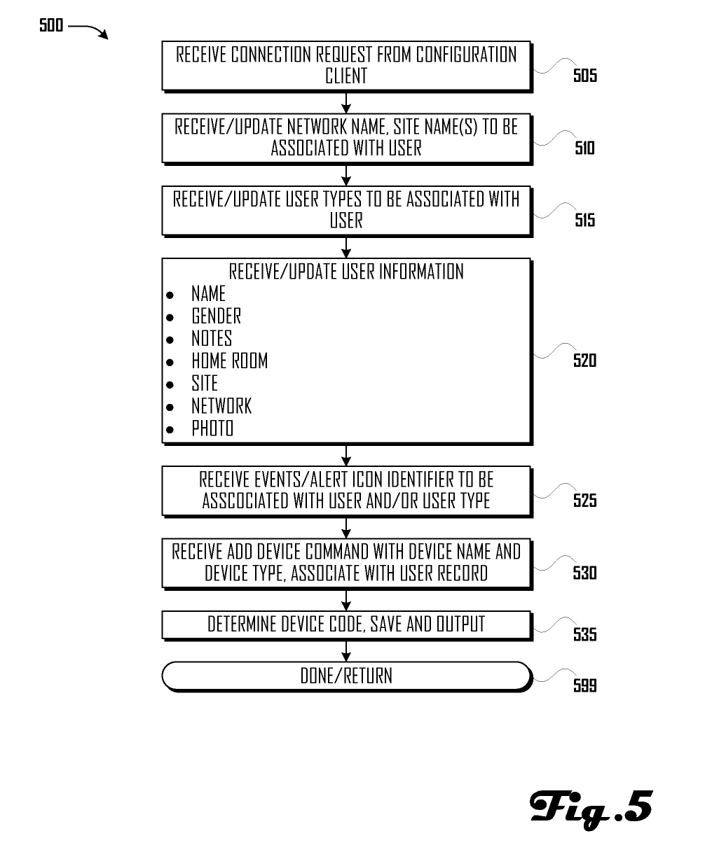

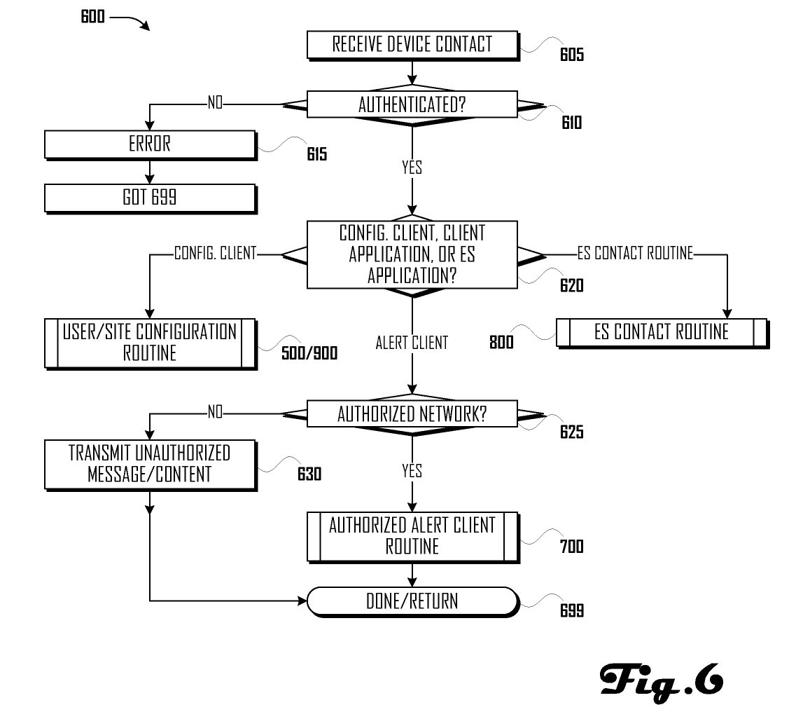

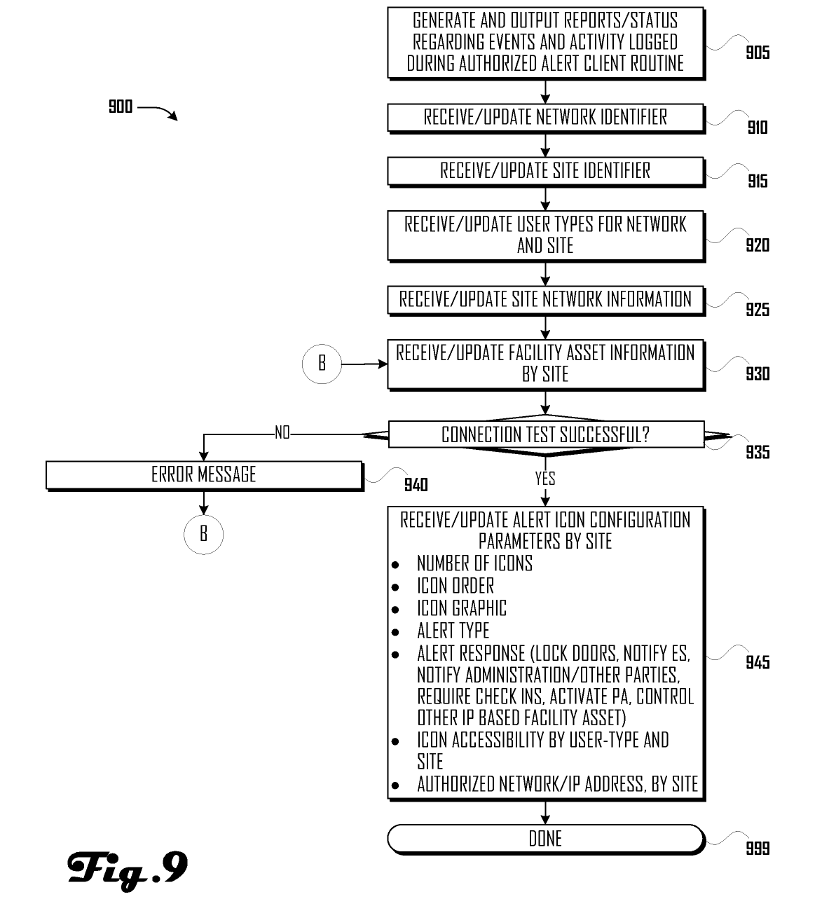

FIG. 4 is a flowchart illustrating an embodiment of Alert Routine 400. Alert Routine 400 may be performed by, for example, Alert Server 200. At block 900, Alert Routine 400 executes Site Report and Configuration Routine 900, discussed in relation to FIG. 9. At block 500, Alert Routine 400 executes User Configuration Routine 500, discussed in relation to FIG. 5. At block 600, Alert Routine 400 executes Device Contact Routine 600, discussed in relation to FIG. 6. At block 499, Alert Routine 400 may exit, may return to an initial state, or may return to a process which spawned Alert Routine 400.

FIG. 5 is a flowchart illustrating an embodiment of User Configuration Routine 500. At block 505 User Configuration Routine 500 may receive a connection request from Configuration Client 110. This request and/or communication session may be between Alert Server 200, which may execute User Configuration Routine 500, and Configuration Client 110, which may communicate with User Configuration Routine 500 via a browser or the like. Configuration Client 110 may be associated with a User and User-Type 335 setup by Site Report and Configuration Routine 900 and may need to provide authentication and authorization credentials as part of block 505.

At block 510, User Configuration Routine 500 may receive Network and Site name(s) or identifiers associated with or saved in Network 305 and/or Site 310 records, which Network 305 and/or Site 310 records are to be associated with a User and User Information 340 records.

At block 515, User Configuration Routine 500 may receive a User Type name or identifier associated with a User Type 335 record, which User Type 335 record is to be associated with a User and User Information 340 records.

At block 520, User Configuration Routine 500 may receive information from, for example, Configuration Client 110 and/or Client Application 350, for a new User Information 340 record and/or may receive an update to an existing User Information 340 record, which may be stored as User Information 340 record(s). As illustrated in block 520, User Information 340 record(s) may comprise entries for, for example, name, gender, notes, home room (or other location assigned to the User), a location (such as a location in Map 385), Site 310, Network 305, and a Photo of the User. Authorization to edit some or all of the User Information 340 record for a User may be delegated to the User and Client Application 350 by Configuration Client 110 and a User thereof.

At block 525, User Configuration Routine 500 may receive an Event Type 380 and/or Alert Icon Identifier 365 associated with Event Type 380, which Event Type 380 and/or Alert Icon Identifier 365 is to be associated with the User and/or User Type 335 then being configured. When associated with a User and when the User executes Client Application 350 on Mobile Device 105, the Alert Icon(s) associated the User at block 525 may be rendered on a user interface in Client Application 350. When rendered on a user interface in Client Application 350, the Alert Icon allows the User to trigger a corresponding Alert (discussed further below in relation to FIG. 6 and Device Contact Routine 600). Alert Icons, Events, and Alert Icon Parameters may be configured by, for example, Site Report and Configuration Routine 900, discussed in relation to FIG. 9.

At block 530, User Configuration Routine 500 may receive an Add Device command and a Name for the device and a Device Type (such as “smart phone,” “feature phone,” “laptop,” “desktop,” etc.), which Name and Device Type information is associated with or stored in a User Information 340 record (and/or User Configuration Routine 500 may receive an instruction to update such records).

At block 535, User Configuration Routine 500 may determine a Device Code 355, associate Device Code 355 with User and User Information 340 record, and output the Device Code 355 to, for example, Configuration Client 110 and/or Mobile Device 105 associated with User and Client Application 350. Device Code 335 is to be entered into Client Application 350 on Mobile Device 105; Device Code 355 as entered into and saved in Mobile Device 105 and/or Client Application 350 as executed by Mobile Device 105 may be a sub-record or entry within the equivalent of a User Information 340 record saved in Client Application 350. Device Code 355 or a product or transformation thereof may be transmitted between Client Application 350 (as executed by a Mobile Device 105) and Alert Server 200 and User Configuration Routine 500 to authenticate a Mobile Device 105 relative to an associated User Information 340 record.

At block 599, User Configuration Routine 500 may return to the Alert Routine 400 or may otherwise conclude.

FIG. 6 is a flowchart illustrating an embodiment of Device Contact Routine 600.

Device Contact Routine 600 may be executed by Alert Server 200. At block 605, Device Contact Routine 600 receives a contact from a computer. At block 610, Device Contact Routine 600 may determine if the contact can be authenticated relative to, for example, a match, which may be a cryptographic match, with, for example, a Device Code 355 associated with a User Information 340 record. If not, block 615 may determine an error, which may include transmitting a result thereof to Mobile Device 105, such as an opportunity to provide authentication and authorization credentials.

If yes at block 610, then at block 620 a determination may be made regarding the device contact is by or from a Configuration Client 110, Client Application 350, or ES Application 360. If a Configuration Client 110, then at block 500/900, the User Configuration Routine 500 and/or Site Report and Configuration Routine 900 may be executed.

If a Client Application 350, then at block 625, a determination may be made regarding whether or not the Client Application 350 is connecting to an authorized Network 305. This determination may be accomplished by obtaining the name, SSID, IP Address or other network information of the network which the Client Application 350 is utilizing and looking up the information in, for example, Alert Datastore 300 and a Site Network Information 325 record to determine if Client Application's 350 network is associated with Site Network Information 325 associated with the Client Application 350 by Site Report and Configuration Routine 900. If not, then at block 630, a message, such as an error message or a message that Client Application 350 is not authorized to activate an Alert, may be transmitted to Client Application 350. In a variation, the Alert Icon may be rendered in Client Application 350 but not made active (or activatable) if Client Application 350 is not utilizing or connecting via an authorized network.

If affirmative at block 625, then at block 700, Authorized Alert Client Routine 700 may be executed.

If, at block 620, the Device Contact was from an ES Application 360, then at block 800, ES Contact Routine may be executed.

At block 699, the Device Contact Routine 600 may conclude and/or return to a process which spawned the Device Contact Routine 600.

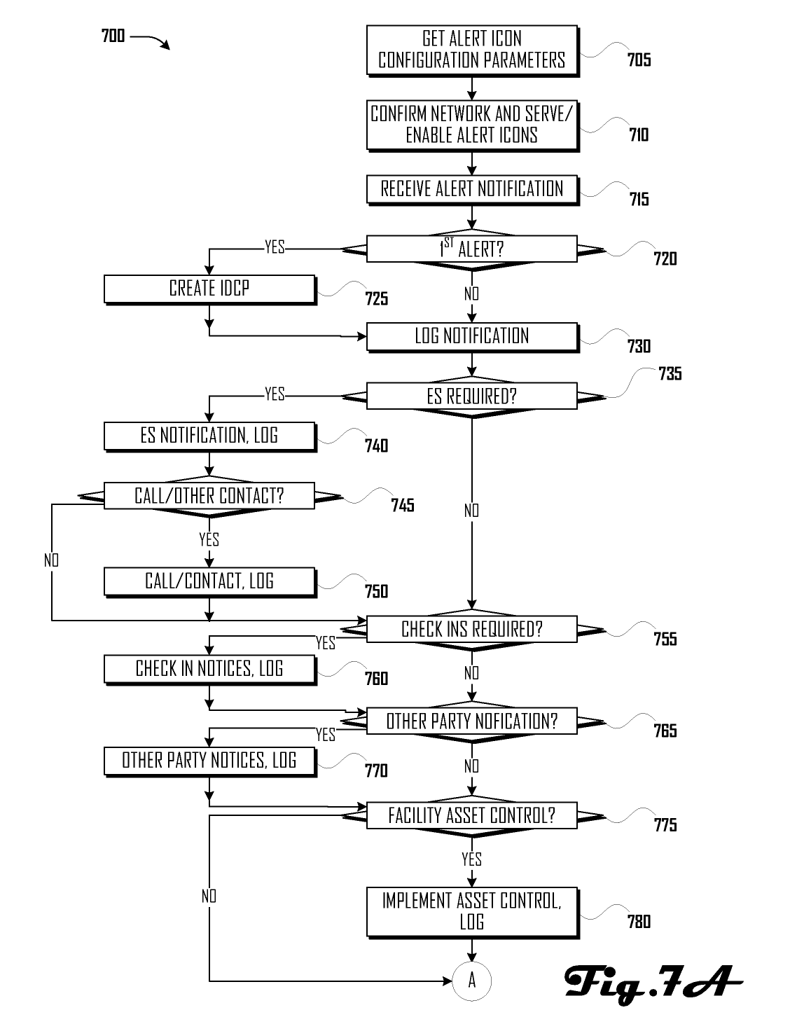

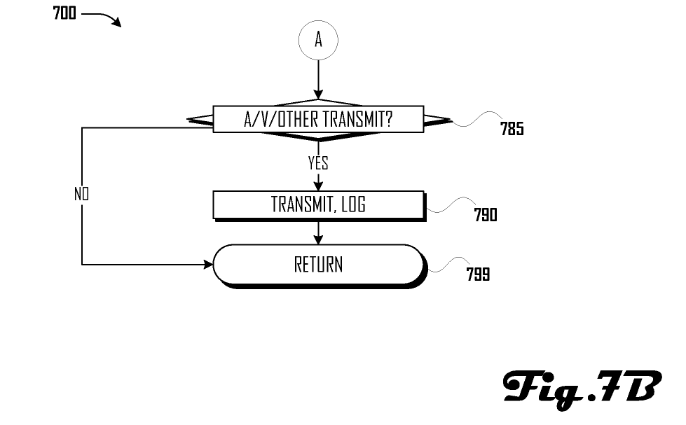

FIGS. 7A and 7B are a flowchart illustrating an embodiment of Authorized Alert Client Routine 700. Authorized Alert Client Routine 700 may be performed by Alert Server 200 interacting with, for example, Client Application 350. Client Application 350 may interact with Authorized Alert Client Routine 700 via an API. At block 705, Authorized Alert Client Routine 700 may obtain Alert Icon Configuration Parameters 315 associated with authorized Client Application 350 contact of block 605. Alert Icon Configuration Parameters 315 describe the Alert Icons displayed in the user interface of Client Application 350 executed by Mobile Device 105. Alert Icon Configuration Parameters 315 may be configured in or by, for example, Site Report and Configuration Routine 900.

At block 710, the Site Network Information 325 associated with the contact may be confirmed, such as to confirm that the Client Application 350 continues to utilize the authorized SSID, and, if confirmed, the Icon(s) associated with the User Type 335 and Site 310 associated with the User Information 340 record are served and/or enabled within the user interface of Client Application 350 as executed by Mobile Device 105.

At block 715, Authorized Alert Client Routine 700 may receive an Alert Notification, such as when a User touches one of the Alert Icons, which touch may be a long touch, such as longer than “X” microseconds, such as 750 microseconds, which touch causes Mobile Device 105 and Client Application 350 thereby, to transmit a notification to Alert Server 200. The touch may further involve a fingerprint, photograph, PIN, or other biometric or memory-based identification of the User (which identification may be confirmed relative to, for example, a User Information 340 record). The Alert notification received at block 715 may comprise an identifier for the Alert Icon (which may be part of the Alert Icon Configuration Parameters 315), a Site identifier, such as Site 310, Site Network Information 325, and any Alert Icon options (which may be part of the Alert Icon Configuration Parameters 315). Site Network Information 325 may be required for all API calls placed by Client Application 350 which must be authenticated or authorized.

At block 720, a determination may be made regarding whether this is the first Alert Notification. This determination may be made based on whether there is already an open IDCP with the identifier for the Alert Icon, Site identifier, and, optionally, the Alert Icon options. If it is, then at block 725, an IDCP 375 record may be created, which IDCP 375 is an Alert Notification tracking identifier, which is associated with the Alert Notification.

At block 730, the Alert Notification may be logged, such as by association with or entry in IDCP 375 record.

At block 735, a determination may be made, such as based on the Alert Response entry in the Alert Icon Configuration Parameter 315, whether ES are required. If they are, then at block 740, a notification may be sent to a User or User Type 335 associated with the Client Application 350 of block 705 (such as to an Administrator or Site Administrator) or per information in the Alert Response entry in the Alert Icon Configuration Parameter 315 informing such party that such party must contact ES or a notification may be sent to ES, such as ES 160, which notice may comprise the location of the Site, the Event Type 380, and User Information 340. The ES notification may also be logged at block 740.

At block 745, a determination may be made regarding whether a voice and/or video connection and/or another type of connection, such as access to the motion, position, orientation, and temperature sensors in Mobile Device 105, should be opened between Mobile Device 105 and ES 160 or with the other party contacted at block 740. At block 750 the connection may be opened. The connection may be opened on Mobile Device 105 without any outward, user-oriented indication. The connection may be logged at block 750.

At block 755, a determination may be made, such as based on the Alert Response entry in the Alert Icon Configuration Parameter 315, whether Check Ins are required. A Check In may be a notice sent to a User, which notice the User must respond to “check in”. The list of Users requiring a Check In may be defined in the Alert Icon Configuration Parameter 315 as Users and/or Users of specific User Types 335 associated with a Site 310 or Network 305.

If yes, then at block 760, the Check In notifications may be sent, logged, and responses thereto may be logged.

At block 765, a determination may be made, such as based on the Alert Response entry in the Alert Icon Configuration Parameter 315 or based on user input, which may be prompted by a query, whether notifications or other communication with or to any other parties, such as School Administration 115, parents, or students are required. If yes, then at block 770, the notifications to other parties may be sent and logged.

At block 775, a determination may be made, such as based on the Alert Response entry in the Alert Icon Configuration Parameter 315, whether a Facility Asset 165 control is to be implemented, such as locking doors, turning on fire suppression equipment, obtaining audio or video from a location, establishing an audio/video connection between ES 160 and audio/visual equipment in the Site or Network, or the like. If yes, then at block 780, the Facility Asset 165 control may be implemented and logged. Facility Asset 165 control may be implemented by commands sent from, for example, Alert Server 200 and Authorized Alert Client Routine 700 to Facility Asset 165, to Hardware Controller 170, and/or to Proxy Server 180. Certain of Facility Assets 165 and/or Hardware Controller 170 may require that they be controlled by a device within the same network, such as by or via Proxy Server 180. For example, an http string may be sent by Alert Server 200 and Authorized Client Routine 700 to Proxy Server 180, such as http://PROXY_Server_IP:9000/?url=http://HARDWARE_IP/index.cgi?relay=1&state=off, in which http string, <PROXY_Server_IP> is an IP address for Proxy Server 180 and <HARDWARE_IP> is an IP address for the Facility Asset 165 to be controlled and wherein Proxy Server 180 will truncate the http string to everything which follows <?url=> and transmit the remainder to the Facility Asset 165 within Site, instructing Proxy Server 180 to turn relay 1 off. In contrast, other Facility Assets 165 may be better control directly, such as a PA system, without mediation of Proxy Server 180. Control configuration may be established during execution of, for example, Site Report and Configuration Routine 900.

At block 785, a determination may be made, such as based on the Alert Response entry in the Alert Icon Configuration Parameter 315 or based on user input whether a voice and/or video connection and/or another type of connection, such as communication of motion, position, orientation, and temperature sensors sensor data from Mobile Device 105 to any other party. At block 790 the connection may be opened. The connection may be opened on Mobile Device 105 without any outward, user-oriented indication. The connection may be logged at block 790.

At block 799, the Authorized Alert Client Routine 700 may end or return.

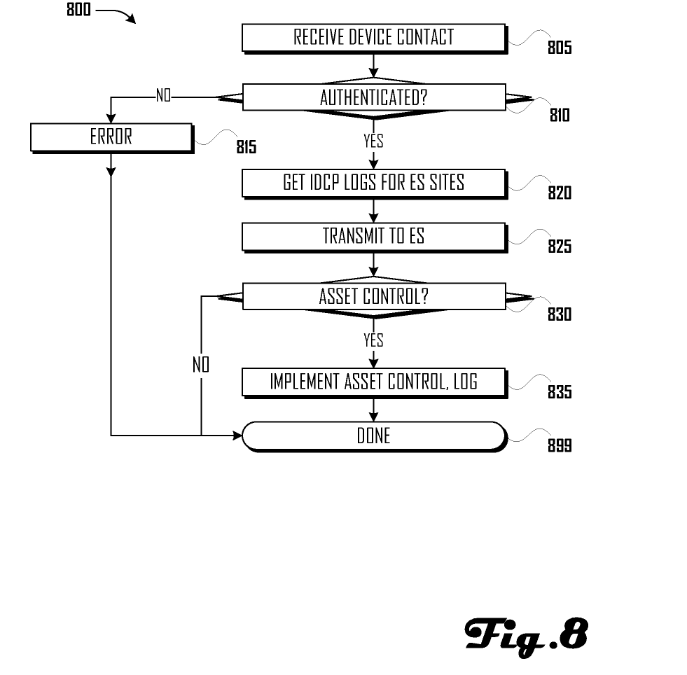

FIG. 8 is a flowchart illustrating an embodiment of ES Contact Routine 800. At block 805, an ES contact may be received, such as from an ES 160 executing the ES Application 360. The ES Application 360 may be a secure browser connection between Mobile Device 105 (which may be a personal computer) to a user interface provided in ES Contact Routine 800 for this purpose and/or ES Application 360 may be an app downloaded to Mobile Device 105; the secure connection may require that the ES Application 360 provide a code. At block 810, a determination may be made regarding whether or not the ES Application 360 is authenticated. If not, then at block 815 an error message may be generated and returned and the ES Contact Routine 800 may end at block 899. If yes at block 810, then at block 820, the IDCP Logs associated with Sites associated with the ES are obtained. At block 825, the obtained logs may be transmitted to the ES.

At block 830, a determination may be made regarding whether the ES has initiated control of a Facility Asset 165. If yes, then at block 835 the control of the Facility Asset 165 may be implemented and logged. At block 899, the ES Contact Routine 800 may return.

FIG. 9 is a flowchart illustrating an embodiment of Site Report and Configuration Routine 900. At block 905, Site Report and Configuration Routine 900 may generate and output, such as to a Super Administrator, Site Administrator, or another authorized User Type 335, reports and status information regarding Event Types 380 and activities of the Alert Server 200, such as those logged during Authorized Alert Client Routine 700. Such reports may be output in, for example, a “dashboard” or similar user interface.

At block 910, the Site Report and Configuration Routine 900 may connect with an authorized User Type 335, such as the User Type 335 of block 905 or otherwise a User Type 335 which may be a Configuration Client 110, and may receive therefrom a new or an updated identifier for a Network, which may be saved as, for example, Network 305 record. At block 915, the Site Report and Configuration Routine 900 may receive a new or an updated identifier for a Site in the Network of block 910, which may be saved as, for example, Site 310 record and which may be associated with Network 305 record of block 910. The Site 310 record may include or be associated with Map 385 record, which may be a map of the Site.

At block 920, Site Report and Configuration Routine 900 may receive a new or an updated User Type(s) 335 record(s), which User Type(s) 335 may be present at the Site of block 915. The User Types may include a User Type which is authorized to act as Configuration Client 110.

At block 925, Site Report and Configuration Routine 900 may receive new or updated Site Network information, such as an SSID, IP Address, and other Network information which may be required for a User Type 335 to initiate an Alert, which information may be stored in, for example, Site Network Information 325 record.

At block 930, Site Report and Configuration Routine 900 may receive new or updated Facility Asset 165 information, such as a type of Asset, a name of Asset, a connection type of a network connection to Asset, connection information for connecting to Asset, an API or command catalog for controlling Asset, and the like, which information may be stored in, for example, Facility Asset 370 record.

At block 935, a determination may be made regarding whether a connection test according to Facility Asset 370 record of block 930 is successful. If not, at block 940, an error message may be output to the User Type 335 accessing Site Report and Configuration Routine 900 (such as the User Type 335 of block 905) and the process may return to block 930, to update the Facility Asset information which did not result in a successful connection.

If affirmative at block 935 or otherwise following 930, at block 945, Site Report and Configuration Routine 900 may receive information from, for example, the User of block 910 or another Configuration Client 110, for a new Alert Icon Configuration Parameter 315 record and/or may receive an update to an existing Alert Icon Configuration Parameter 315 record, which may be stored as an Alert Icon Configuration Parameter 315 record(s).

As illustrated in block 945, Alert Icon Configuration Parameter 315 record(s) may comprise entries for, for example, a number of Alert Icons, an order of the Alert Icons (as displayed in the Client Application 350), a graphic for an Alert Icon, an Event Type 380, Alert Responses (such as locking doors, turning on and/or accessing data stored by cameras and/or microphones in Mobile Devices 105 and in Facility Assets 165, obtaining location data from or regarding Mobile Devices 105 such as from GPS data or Indoor Positioning System data) notifying ES, notifying or establishing a communication session with School Administration or others, requiring a Check In (including from which Users or User Types 335), activating or obtaining information regarding a Facility Asset 165, such as connecting a User to and activating a PA), the accessibility of the Alert Icon by different Users and/or User Types 335 (which may further specify accessibility by Site, for Users who move between Sites) which determines whether Alert Icons are displayed on Mobile Device 105 of Users, and Site Network Information 325 required to authorize a Client Application 350 to activate an Alert Icon.

At block 999, Site Report and Configuration Routine 900 may conclude or return to a process which spawned it, such as Alert Routine 400.

The above Detailed Description of embodiments is not intended to be exhaustive or to limit the disclosure to the precise form disclosed above. While specific embodiments of, and examples are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. Further, any specific numbers noted herein are only examples; alternative implementations may employ differing values or ranges.

1. A computer implemented method of managing alerts in an institutional setting, the method comprising:
at a first computer, receiving from a second computer associated with a first site in a network of institutional sites a set of user-type parameters which set of user-type parameters define a first user-type, wherein the first user-type may be present at the first site or a second site in the network of institutional sites;
at the first computer, associating a first alert with a first alert-identifier;
at the first computer, associating the first alert-identifier with a set of alert-parameters which alert-parameters comprise a first alert-type, a first alert-icon, a first alert-response, a first authorized user-type, which first authorized user-type may give an instruction to implement the first alert-response, and a first computer network identifier of a computer network which the first authorized user-type must utilize when giving the instruction to implement the first alert-response;
at the computer, receiving a request from a third computer to enable, in the third computer, the first alert-icon to send a request for the first alert-response, which request for the first alert-response comprises an alert-identifier and a computer network identifier;
determining whether the third computer is authorized to enable the first alert-icon in the third computer based at least in part on whether the computer network identifier received in the request is the first computer network identifier and whether the alert-identifier received in the request is the first alert-identifier, and, when the third computer is authorized to enable the first alert-icon, responding to the request by enabling the first alert-icon in the third computer to send a request for the first alert-response;
at the computer, following enablement of the first alert-icon in the third computer, receiving from the third computer the first alert-identifier, a computer network identifier and a request to implement the first alert-response;
at the computer, following receipt of the request to implement the first-alert response, determining if the computer network identifier received with the request for the first alert-response is the first computer network identifier and, if it is,
implementing the first alert-response.

2. The method according to claim 1, wherein the alert-parameters are received from the second computer.

3. The method according to claim 1, wherein the first computer network identifier is a service set identifier (“SSID”) of a wireless network.

4. The method according to claim 1, wherein the alert-response comprises sending a notice to a specific user or to user-types at the first site in the network of institutional sites, which notice requests that the user or user-types check in with the first computer.

5. The method according to claim 4, wherein the first alert-response comprises transmitting the notice requesting that the user or user-types check in with the first computer and further comprising determining if the check in was performed.

6. The method according to claim 1, wherein the alert-response comprises at least one of contacting emergency services, contacting a party other than emergency services, controlling a remotely controllable facility asset at the first site or a second site in the network of institutional sites, and establishing a live audio and/or visual connection between a computer at the first site or a second site in the network of institutional sites and another party.

7. The method according to claim 6, wherein the contact with emergency services is a contact between the third computer and the emergency services.

8. The method according to claim 6, wherein the contact with emergency services is a contact between a fourth computer and the emergency services.

9. The method according to claim 6, wherein the remotely controllable facility asset is at least one of a door lock, a power door, a motion detector, a fire alarm, a fire suppression system, a water valve, an electrical circuit breaker, a circuit breaker, a public address system, a phone system, a still or video camera, and an electric light.

10. The method according to claim 1, wherein the user-types comprise a super administrator, a network administrator, and a site user.

11. The method according to claim 1, wherein the alert-types comprise at least one of a fire, a flood, a robbery, an earthquake, an assault, a kidnapping, a missing person, and an unauthorized person present at a site.

12. The method according to claim 1, further comprising receiving from the second computer user-record parameters, which user-record parameters comprise user information for a user of the third computer and a device type of the third computer.

13. The method according to claim 12, further comprising determining a device code and, prior to receiving the request from the third computer to enable the first alert-icon in the third computer, securely transmitting the device code to the third computer.

14. The method according to claim 13, further comprising receiving the device code with the request from the third computer to enable the first alert-icon in the third computer.

15. The method according to claim 1, wherein the alert-parameters further comprise an order of alert-icons in a display in the third computer.

16. The method according to claim 1, wherein the alert-parameters further comprise a number of alert-icons in a display in the third computer.

17. The method according to claim 1, further comprising receiving from the second computer information regarding a facility asset, which facility asset is located at the first site and wherein the first alert-response comprises controlling the facility asset.

18. The method according to claim 1, further comprising generating a report comprising logged communications associated with implementation of the first alert-response.

19. A non-transient computer-readable storage medium having stored thereon instructions that, when executed by a processor in a first computer, configure the processor to:
receive from a second computer associated with a first site in a network of institutional sites a set of user-type parameters which set of user-type parameters define a first user-type, wherein the first user-type may be present at the first site or a second site in the network of institutional sites;
associate a first alert with a first alert-identifier;
associate the first alert-identifier with a set of alert-parameters which alert-parameters comprise a first alert-type, a first alert-icon, a first alert-response, a first authorized user-type, which first authorized user-type may give an instruction to implement the first alert-response, and a first computer network identifier of a computer network which the first authorized user-type must utilize when giving the instruction to implement the first alert-response;
receive a request from a third computer to enable, in the third computer, the first alert-icon to send a request for the first alert-response, which request for the first alert-response comprises an alert-identifier and a computer network identifier;
determine whether the third computer is authorized to enable the first alert-icon in the third computer based at least in part on whether the computer network identifier received in the request is the first computer network identifier and whether the alert-identifier received in the request is the first alert-identifier, and, when the third computer is authorized to enable the first alert-icon, responding to the request by enabling the first alert-icon in the third computer to send a request for the first alert-response;
following enablement of the first alert-icon in the third computer, receive from the third computer the first alert-identifier, a computer network identifier and a request to implement the first alert-response;
following receipt of the request to implement the first-alert response, determine if the computer network identifier received with the request for the first alert-response is the first computer network identifier and, if it is,
implement the first alert-response.

20. A first computing apparatus for managing alerts in an institutional setting, the first computing apparatus comprising a processor and a memory storing instructions that, when executed by the processor, configure the first computing apparatus to:
receive from a second computer associated with a first site in a network of institutional sites a set of user-type parameters which set of user-type parameters define a first user-type, wherein the first user-type may be present at the first site or a second site in the network of institutional sites;
associate a first alert with a first alert-identifier;
associate the first alert-identifier with a set of alert-parameters which alert-parameters comprise a first alert-type, a first alert-icon, a first alert-response, a first authorized user-type, which first authorized user-type may give an instruction to implement the first alert-response, and a first computer network identifier of a computer network which the first authorized user-type must utilize when giving the instruction to implement the first alert-response;
receive a request from a third computer to enable, in the third computer, the first alert-icon to send a request for the first alert-response, which request for the first alert-response comprises an alert-identifier and a computer network identifier;
determine whether the third computer is authorized to enable the first alert-icon in the third computer based at least in part on whether the computer network identifier received in the request is the first computer network identifier and whether the alert-identifier received in the request is the first alert-identifier, and, when the third computer is authorized to enable the first alert-icon, responding to the request by enabling the first alert-icon in the third computer to send a request for the first alert-response;
following enablement of the first alert-icon in the third computer, receive from the third computer the first alert-identifier, a computer network identifier and a request to implement the first alert-response;
following receipt of the request to implement the first-alert response, determine if the computer network identifier received with the request for the first alert-response is the first computer network identifier and, if it is,
implement the first alert-response.
